(19) United States
(12) Patent Application Publication
(10) Pub. No.: US 2006/0219511 A1
(43) Pub. Date: Oct. 5, 2006

(54) One-way clutch and method for assembling same

(75) Inventors: Kazuhiko Muramatsu, Fukuroi-shi (JP); Taiji Kamiya, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 11/389,174

(22) Filed: Mar. 27, 2006

(30) Foreign Application Priority Data
Mar. 31, 2005 (JP) 2005-102058

(51) Int. Cl. F16D 41/07

(52) U.S. Cl. 192/45.1; 29/446

(57) ABSTRACT

The present invention provides a one-way clutch comprising an outer race having an annular inner peripheral track surface, an inner race having an annular outer peripheral track surface and spaced apart from the outer race inwardly in a radial direction and disposed concentrically and rotatable integrally with respect to the outer race, torque transmitting members disposed between the outer race and the inner race to transmit torque therebetween, and a holder disposed between the inner race and the outer race and including a cylindrical portion and an annular flange extending from an axial one edge of the cylindrical portion radially outwardly and adapted to hold the torque transmitting members equidistantly along a circumferential direction via the cylindrical portion and wherein the cylindrical portion and the flange portion of the holder are configured to have a substantially true circular shape and the inner peripheral track surface of the outer race is configured to have a true circular shape, and a diameter of the inner peripheral track surface of the outer race is the substantially the same as an outer diameter of the flange portion of the holder, and the flange portion is frictionally engaged by the outer race with predetermined drag torque therebetween.

### BACKGROUND OF THE INVENTION

1. Field of the Invention

The present invention relates to a one-way clutch used as a device such as a torque transmitting device, a back stopper and the like in a driving apparatus, for example, of a motor vehicle and the like, and more particularly it relates to an improvement in a holder of such a one-way clutch. Further, the present invention relates to a method for performing the assembling with respect to an outer race of such a holder.

1. Related Background Art

In the past,when a one-way clutch was incorporated into a rotary member of an industrial machine and the like and was used therewith, in order not to worsen a function of the one-way clutch due to vibration and/or inertia, the one-way clutch was held so that given drag torque was applied onto an outer race or an inner race as the rotary member.

For example, if the outer race is accelerated or decelerated quickly, splugs are slipped in a track of the outer race due to inertia to cause friction, it is necessary that a friction force or drag torque be applied between an outer holder and the outer race to always rotate the holder along with the outer race. The reason is that a movement of the outer race must be transmitted to the outer holder quickly and positive movement of the splugs must be achieved. In order to obtain such given drag torque, in conventional one-way clutches, a technique in which a flange portion of the outer holder is configured to have an elliptical shape was adopted (refer to Japanese Utility Model Application Laid-open No. S62-188632 (1987)). In addition, the outer holder is provided with a projection (refer to Japanese Utility Model Application Laid-Open No. H05-54831 (1993)). Alternatively, an i-bar, a T-bar or a drag clip was used to generate the drag torque.

However, the above-mentioned conventional clutches cause the following problems. First of all, if projections are provided on the outer holder, since the number of manufacturing steps is increased, a manufacturing cost will be increased.

Further, if the flange portion of the holder (or the entire holder) is configured to have the elliptical shape, it is difficult to achieve the elliptical shape of the flange portion or the entire holder and to manage or control a dimension in order to maintain the elliptical shape during use. Further, for example, as shown in.FIG. 7, as a whole, in the conventional outer holders, since contact area between the holder and the track surface of the outer race is relatively small, stable drag torque cannot be obtained.

The conventional elliptical holder is used as an outer holder of a dual holder and contributes to generation of moderate drag torque between the holder and the outer race thereby to stabilize an engaging performance in a lock condition.

In the one-way clutch, the outer and inner holders are concentrically disposed between the outer and inner races to support splugs arranged equidistantly along a circumferential direction. Further, a ribbon spring for biasing the splugs toward an engaging direction is arranged between the inner and outer holders in the circumferential direction to engage the one-way clutch positively.

Although the elliptical holder is widely used because the manufacturing thereof is easier in comparison with an i-bar and a T-bar, due to the characteristics of the configuration, a uniform distance cannot be obtained between the elliptical shape of the outer holder and the circular shape of the inner holder, with the result that wide areas and narrow areas are generated along the elliptical shape.

As a result, when the one-way clutch is operated repeatedly, since a relative rotational movement is generated between the outer holder and the inner holder in response to movements of the splugs, in the narrow areas, the ribbon spring disposed between the holders may be contacted with the outer holder repeatedly under a severe condition, thereby causing partial wear of the ribbon spring.

### SUMMARY OF THE INVENTION

Accordingly, an object of the present invention is to provide a one-way clutch comprising a holder having a true circular shape and having a function same as that of an elliptical holder, in order to prevent interference between the holder and a ribbon spring while taking advantage of an elliptical cage or holder.

Further, another. object of the present invention is to provide a one-way clutch having a simple construction, in which stable drag torque can be obtained without reduction of strength of a holder and without increase in a manufacturing cost.

To achieve the above object, the present invention provides a one-way clutch comprising an outer race having an annular inner peripheral track surface, an inner race having an annular outer peripheral track surface and spaced apart from the outer race inwardly in a radial direction and disposed concentrically and rotatable integrally with respect to the outer race, torque transmitting members disposed between the outer race and the inner race to transmit torque therebetween, and a holder disposed between the inner race-and the outer race and including a cylindrical portion and an annular flange extending from an axial one edge of the cylindrical portion radially outwardly and adapted to hold the torque transmitting members equidistantly along a circumferential direction via the cylindrical portion and wherein the cylindrical portion and the flange portion of the holder are configured to have a substantially true circular shape and the inner peripheral track surface of the outer race is configured to have a true circular shape, and a diameter of the inner peripheral track surface of the outer race is the substantially the same as an outer diameter of the flange portion of the holder, and the flange portion is frictionally engaged by the outer race with predetermined drag torque therebetween.

Further, the present invention provides a method for assembling a holder to an outer race in a one-way clutch comprising an outer race having an annular and true circular inner peripheral track surface, an inner race having an annular outer peripheral track surface and spaced apart from the outer race inwardly in a radial direction and disposed concentrically and rotatable integrally with respect to the outer race, torque transmitting members disposed between the outer race and the inner race to transmit torque therebetween, and a holder disposed between the inner race and the outer race and including a substantially true circular cylindrical portion and an annular and substantially true circular flange extending from an axial one edge of the cylindrical portion radially outwardly and adapted to hold the torque transmitting members equidistantly along a circumferential direction via the cylindrical portion,.wherein, after the holder is deformed, the holder is assembled to the inner peripheral track surface of the outer race.

With such arrangements, since a contact area between the outer race and the holder is increased in comparison with those in conventional one-way clutches, not only time-lapse change or variation is reduced and required stable drag torque can be obtained, but also a one-way clutch in which interference between the holder and a ribbon spring can be prevented and a service life thereof is not decreased can be provided. Since the holder deformed to have an elliptical shape or a polygonal shape is assembled to the inner peripheral track surface (track surface) of the outer race to contact the holder with the outer race along a substantially true circle, the one-way clutch is hard to be inclined around a longitudinal axis. Further, since the contact area is increased, the time-lapse change due to wear is hard to be generated. As a result, since the relative rotation between the holder and the outer race is hard to be occurred, the required frictional drag torque can be derived from the contact area and the posture of the one-way clutch within the outer race can be stabilized.

### BRIEF DESCRIPTION OF THE DRAWINGS

FIG. 1 is an axial sectional view of a one-way clutch according to an embodiment of the present invention;

FIG. 2 is a front view of an outer holder;

FIG. 3 is a front view of the outer holder deformed to have an elliptical shape;

FIG. 4 is a front view of the one-way clutch in which the outer holder of FIG. 3 is fitted into and assembled to an outer race;

FIG. 5 is a front view of a one-way clutch according to another embodiment of the present invention;

FIG. 6 is a front view of a one-way clutch according to a further embodiment of the present invention; and

FIG. 7 is a front view of a conventional one-way clutch.

### DESCRIPTION OF THE PREFERRED EMBODIMENTS

Now, the present invention will be fully described with reference to the accompanying drawings. Incidentally, it should be noted that embodiments of the present invention which will be described hereinbelow are merely exemplary and do not intend to limit the present invention in all senses. Further, in the drawings, same or similar parts or elements are designated by the same reference numerals.

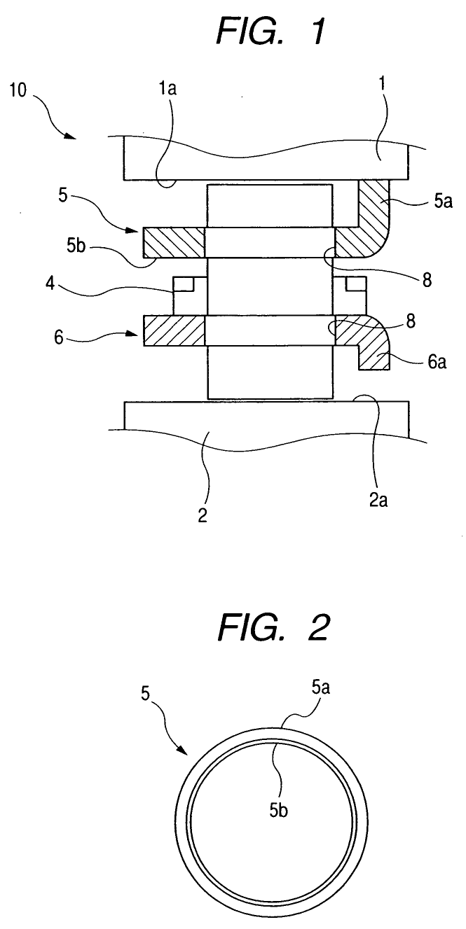

FIG. 1 is an axial sectional view of a one-way clutch 10 according to an embodiment of the present invention. In this case, while an example that gourd-shaped splugs are used as torque transmitting members will be explained, the present invention can be applied to any one-way clutches having other type torque transmitting members. In FIG. 1, an outer race 1 has a substantially true circular inner peripheral track surface 1a. Further, an inner race 2 has a substantially true circular outer peripheral track surface 2a. The outer race 1 and the inner race 2 can be rotated relatively in a condition that the track surfaces 1a and 2a are opposed to each other.

Within an annular space defined between the outer race 1 and the inner race 2, there are disposed a plurality of torque transmitting members i.e. splugs 3 arranged equidistantly along a circumferential direction to transmit torque between the outer race and the inner race. The splugs 3 are held in substantially rectangular windows 8 provided in a pair of holders, i.e. an outer holder 5 and an inner holder 6, respectively. Each window 8 of the outer holder 5 and the inner holder 6 is defined by upper and lower peripheral edges and a circumferential wall therebetween of each holder. A ribbon spring 4 is disposed between the outer holder 5 and the inner holder 6 and serves to apply rising moment to the splugs 3 to be engaged by the track surfaces of the inner race 2 and the outer race 1.

As can be seen from FIG. 1, the inner holder 6 having a substantially true circular outer diameter comprises a cylindrical portion 6a, and an annular flange portion 6a formed integrally with the cylindrical portion 6b and extending, at its axial one end, perpendicularly or radially inwardly by a predetermined distance, and a tip end of the flange portion 6a is opposed to the inner race 2 with a predetermined clearance therebetween.

Further, the outer holder 5 having a substantially true circular inner diameter comprises a cylindrical portion 5b, and an annular flange portion 5a formed integrally with the cylindrical portion 5b and extending, at its axial one end, perpendicularly or radially inwardly by a predetermined distance.

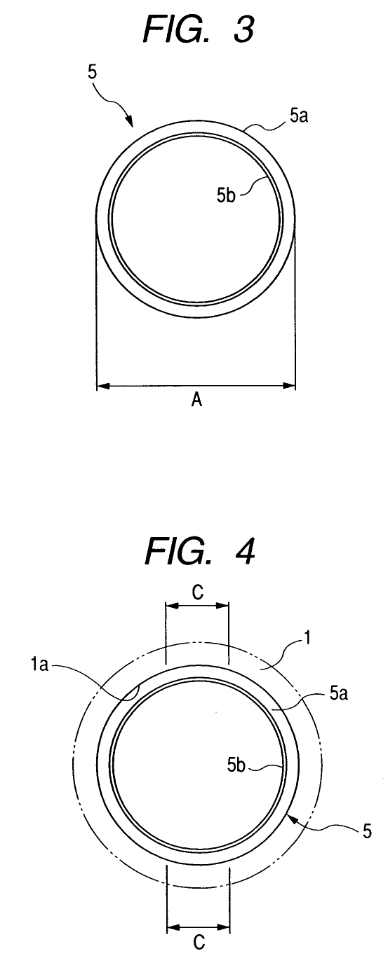

Now, an assembling procedure to the outer race 1 of the outer holder 5 of the one-way clutch 10 According to the present invention will be explained with reference to FIGS. 2 to 4. First of all, as shown in FIG. 2, the outer holder 5 comprises the substantially true circular flange portion 5a and the substantially true circular cylindrical portion 5b formed integrally with the flange portion. Accordingly, the outer holder 5 is substantially true circular as a whole. Further, a diameter of the inner peripheral track surface 1a of the outer race is the substantially the same as an outer diameter of the flange portion 5a of the outer holder 5.

Then, the outer holder 5 of FIG. 2 is urged in a left-and-right direction by using a device (not shown) to deform the outer holder wholly into an elliptical Shape to obtain a shorter diameter A. In this case, a larger diameter of the ellipse becomes greater than a diameter of the inner peripheral track surface 1a of the outer race 1. After the outer holder is deformed into the elliptical shape, as shown-in FIG. 4, the larger diameter side of the outer holder 5 is elastically deformed, and the resulting outer holder is assembled to be fitted into the inner peripheral track surface la of the outer race 1. When assembled in this way, the outer holder 5 is changed into a substantially true circular shape so that relatively large contact areas C are formed in a circumferential direction between the inner peripheral track surface 1a of the outer race 1 and the edge of the flange portion 5a. As a result, the flange portion 5a of the outer holder 5 is frictionally engaged by the inner peripheral track surface 1a of the outer race 1 with predetermined drag torque.

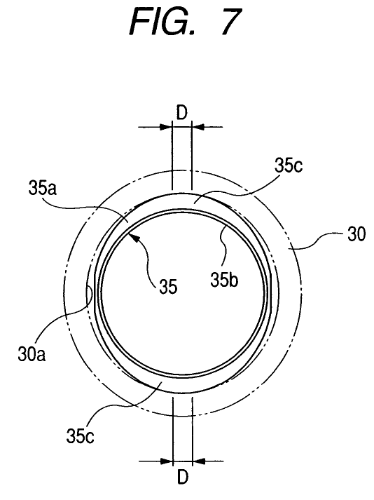

Now, an assembling relationship between an outer race 30 and a holder 35 in a conventional one-way clutch 50 will be explained with reference to FIG. 7. In the holder comprising a substantially true circular cylindrical portion 35b and an elliptical flange portion 35a, swelled portions 35c contacting with an inner peripheral track surface 30a of the outer race 30 are formed at both longer diameter sides of the ellipse. In this way, by contacting the swelled portions 35c situated at the both large diameter side of the ellipse with the inner peripheral track surface 30a of the outer race 30, required drag torque is obtained. As can be seen from FIG. 7, a ratio of each of contact areas D between the inner peripheral track surface 30a and the swelled portions 35c to the whole circumferential length is smaller than that of the contact area C shown in FIG. 4.

In the above-mentioned embodiment, while an example that the holder is deformed to the elliptical shape before assembled was explained, the holder may be deformed to appropriate shapes other than the ellipse, such as a polygonal shape. Although the outer race can be formed as the true circular shape by cutting metal having high rigidity, since the holder is formed from a relatively thin annular plate, the holder can also be formed as a substantially true circular shape but cannot be formed as the true circular shape with high accuracy as the outer race. Accordingly, the holder is subjected to distortion or deformation to some extent. By utilizing such distortion or deformation positively, the flange portion of the holder is deformed as various shapes including the ellipse, polygon and the like and is frictionally engaged by the outer race.

Further, such distortion can be created intentionally. To this end, the holder is previously deformed as a substantially elliptical shape or a polygonal shape. If the holder is deformed as a triangular shape, since the flange portion is contacted with the inner peripheral track surface of the outer race at three points, the holder cannot be rotated with respect to the outer race.

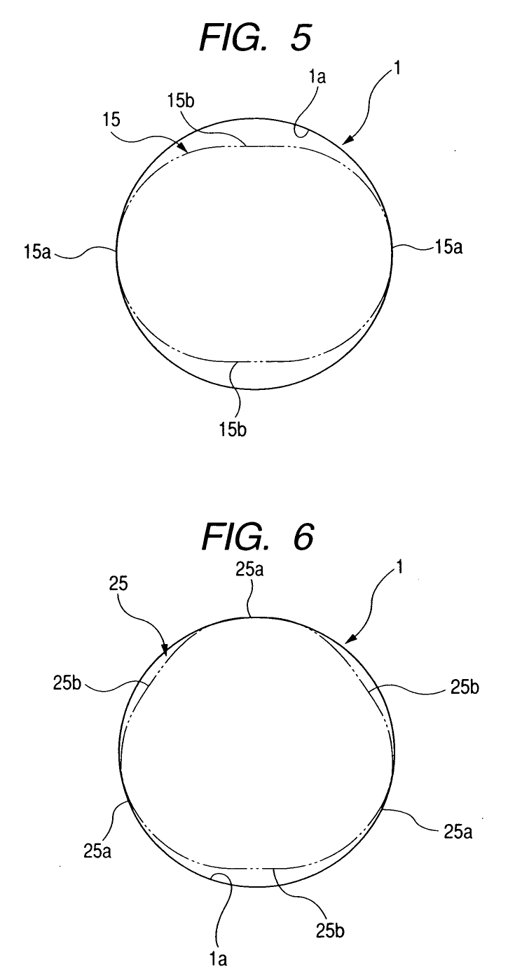

As an example of such a shape, for example, in FIG. 5, a holder 15 has an oval shape as a whole. The holder 15 is contacted with the inner peripheral track surface 1a of the outer race 1 at two points 15a substantially opposed diametrically, i.e. spaced apart from each other substantially 180 degrees along a circumferential direction. Further, two slightly concave portions 15b substantially opposed diametrically, i.e. spaced apart from each other substantially 180 degrees along the circumferential direction are created at middle points between the contact points 15a. Incidentally, a distance between the concave portion 16b and the track surface 1a is shown exaggeratedly.

Due to the presence of the two contact points 15a, the drag torque based on a required friction force from the contact areas between the outer race and the holder, and a posture of the one-way clutch is stabilized within the outer race.

FIG. 6 shows another shape of the holder. In FIG. 6, a holder 25 is contacted with the track surface 1a of the outer race 1 at three points. More particularly, the holder 25 is contacted with the track surface la of the outer race 1 at three points 25a disposed equidistantly along the circumferential direction. Further, three slightly concave portions 25b disposed equidistantly along the circumferential direction are created at middle points between the adjacent contact points 25a. Incidentally, similar to FIG. 5, also in FIG. 6, a distance between the concave portion 25b and the track surface 1a is shown exaggeratedly.

Due to the presence of the three contact points 25a, the drag torque based on a required friction force from the contact areas between the outer race and the holder, and a posture of the one-way clutch is stabilized within the outer race. Incidentally, although the number of the contact points 25a is preferably at least three, four or more contact points may be used.

Incidentally, in the explanation regarding the above-mentioned embodiments, while an example that the one-way clutch includes two holders, i.e. outer and inner holders was explained, it should be noted that the present invention can be applied to a one-way clutch having a single holder. Further, the present invention can be applied to a one-way clutch using end bearings.

This application claims priority from Japanese Patent Application No. 2005-102058 filed on Mar. 31, 2005, which is hereby incorporated by reference herein.

What is claimed is:

1. A one-way clutch comprising:
an outer race having an annular inner peripheral track surface;
an inner race having an annular outer peripheral track surface and spaced apart from said outer race inwardly in a radial direction and disposed concentrically and rotatable integrally with respect to said outer race;
torque transmitting members disposed between said outer race and said inner race to transmit torque therebetween; and
a holder disposed between said inner race and said outer race and including a cylindrical portion and an annular flange portion extending from an axial one edge of said cylindrical portion radially outwardly and adapted to hold said torque transmitting members equidistantly along a circumferential direction via said cylindrical portion; and wherein
said cylindrical portion and said flange portion of said holder are configured to have a substantially true circular shape and said inner. peripheral track surface of said outer race is configured to have a true circular shape, and a diameter of said inner peripheral track surface of said outer race is the substantially the same as an outer diameter of said flange portion of said holder, and said flange portion is frictionally engaged by said outer race with predetermined drag torque therebetween.

2. A one-way clutch according to claim 1, wherein, after said holder is deformed to have a predetermined shape, said holder is fitted into said inner peripheral track surface of said outer race.

3. A one-way clutch according to claim 2, wherein said predetermined shape is a substantially circular shape provided at its outer periphery with at least one concave portion directing radially inwardly.

4. A one-way clutch according to claim 2, wherein said predetermined shape is a polygonal shape.

5. A one-way clutch according to claim 2, wherein said predetermined shape is a substantially elliptical shape provided at its outer periphery with at least two or more concave portions directing radially inwardly.

6. A one-way clutch according to claim 2, wherein said holder is contacted with said track surface of said outer race at three or more points.

7. A one-way clutch according to claim 1, wherein said one-way clutch comprises a pair of outer and inner holders.

8. A method for assembling a holder to an outer race in a one-way clutch comprising an outer race having an annular and true circular inner peripheral track surface, an inner race having an annular outer peripheral track surface and spaced apart from said outer race inwardly in a radial direction and disposed concentrically and rotatable integrally with respect to said outer race, torque transmitting members disposed between said outer race and said inner race to transmit torque therebetween; and a holder disposed between said inner race and said outer race and including a substantially true circular cylindrical portion and an annular and substantially true circular flange extending from an axial one edge of said cylindrical portion radially outwardly and adapted to hold said torque transmitting members equidistantly along a circumferential direction via said cylindrical portion, wherein:
after said holder is deformed, said holder is assembled to said inner peripheral track surface of said outer race.

9. A method according to claim 8, wherein said holder is deformed to have an elliptical shape and then is assembled into said inner peripheral track surface of said outer race.

10. A method according to claim 8, wherein said holder is deformed to have a substantially polygonal shape and then is assembled into said inner peripheral track surface of said outer race.

11. A method according to claim 8, wherein said one-way clutch comprises a pair of outer and inner holders.
